(19) United States
(12) Patent Application Publication
(10) Pub. No.: US 2004/0158543 A1
(43) Pub. Date: Aug. 12, 2004

(54) Self-programmable chip

(76) Inventors: Fathi M. Salam, Okemos, MI (US); Khurram Waheed, East Lansing, MI (US)

Correspondence Address: HARNESS, DICKEY & PIERCE, P.L.C., P.O. BOX 828, BLOOMFIELD HILLS, MI, 48303, US

(21) Appl. No.: 10/773,050

(22) Filed: Feb. 5, 2004

Related U.S. Application Data
(63) Continuation of application No. PCT/US02/24916, filed on Aug. 6, 2002.
(60) Provisional application No. 60/310,674, filed on Aug. 7, 2001.

(51) Int. Cl. G06F 17/10; G06G 7/00; G06F 15/18; G06E 3/00; G06E 1/00

(52) U.S. Cl. 706/26; 708/300

(57) ABSTRACT

A self-programmable chip for real-time estimation, prediction, and control includes a reconfigurable array processing network for compatibility with Very Large Scale Integration (VLSI). The reconfigurable array processing network provides a feed-forward neural network and learning modules, wherein a synapse cell structure (10) provides synapse cells (100) having on-chip learning integrated therein. The chip has a control cell structure (20) including at least one control cell (110) providing digital memory and control modules supplying ordered signal routing functionality and operational modes for the chip.

### CROSS-REFERENCE TO RELATED APPLICATIONS

This application is a continuation of PCT/US02/24916, filed on Aug. 6, 2002, which claims priority to provisional U.S. Patent Application No. 60/310,674, filed on Aug. 7, 2001. The disclosure of the above applications are incorporated herein by reference.

### FIELD OF THE INVENTION

The present invention generally relates to adaptive Very Large Scale Integration (VLSI) neurosystems, and particularly relates to a mixed-mode design for a self-programmable chip for real-time estimation, prediction, and control.

### BACKGROUND OF THE INVENTION

Two challenges particularly arise in the application domains of process identification modeling prediction and real-time control, two challenges arise in particular. Specifically, an accurate mathematical model process cannot be explicitly developed or is not reliable owing to the process's complexity and/or temporal and direct changes. In these cases, models may be “learned” from measurements and data, and subsequent decisions can be executed on line.

One exemplary application is a “smart probe” in the medical and biological fields for biological cell measurement and stimulation where no reliable process model exists and where decisions have to be made on-line. Applications in this domain include drug injections and microsurgery. Another example application is determination or modeling of combustion quality in vehicle engines to detect misfiring and its consequences on exhaust gases and the environment.

Both of the aforementioned application domains generate a huge amount of signals or data that require massive processing for standard computing paradigms. Similar challenging problems exist in pattern matching, feature extraction, and data mining. Unfortunately, software can only compute off-line and in a non-real-time mode for relatively simple models. In answer to these problems, others have attempted to develop self-learning or self-programmable chips.

Some attempted solutions, for example, have accomplished a hardware implementation of a neural network on a chip-set, with learning implemented in hardware on a separate chip of the chip set. A primary disadvantage of this attempted solution includes increased signal noise resulting from routing the signal off chip and/or between chips, and general unsuitability for implementation on, for example, the tip of a medical probe.

Information on related technology may be found in: Gert Cauwenberghs and M. Bayoumi, (editors) Learning on Silicon, adaptive VLSI neural systems, Kluwer Academic Publishers, July 1999; Hwa-Joon Oh and Fathi M Salam, “Analog CMOS Implementation of Neural Network for Adaptive Signal Processing,” Proc. of The IEEE International Symposium on Circuit and Systems, London, England, May 30-Jun. 2, 1994, pp. 503-506; F. M. Salam, H-J Oh, “Design of a Temporal Learning Chip for Signal Generation and Classification,” Analog Integrated Circuits and Signal Processing, an international journal, Kluwer Academic Publishers, Vol. 18, No. 2/3, February 1999, pp. 229-242; M. Ahmadi and F. Salam, “Special Issue on Digital and Analog Arrays, International Journal on Circuits, Systems, and Computers,” October/December 1998 (Issue published in December 1999); and U.S. Pat. No. 5,689,621 entitled “Modular Feedforward Neural Network Architecture with Learning,” issued to Salam et al. The U.S. patent is incorporated herein by reference.

### SUMMARY OF THE INVENTION

In accordance with the present invention, a self-programmable chip for real-time estimation, prediction, and control includes a reconfigurable array processing network. In another aspect of the present invention, the reconfigurable array processing network provides a feed-forward neural network and learning modules. Yet another aspect of the present invention employs a chip which also includes a plurality of control blocks providing digital memory and control modules supplying ordered signal routing functionality for the processing network. In another aspect, the present invention is a method of operating a self-programmable chip for real-time estimation, prediction, and control. Still another aspect of the present invention provides a method which includes activating a learning mode, activating a storage mode, and activating a process mode.

In a further aspect, the present invention is a synaptic cell with on-chip learning and weight storage integrated therein, wherein the synaptic cell is implemented in hardware on a single chip. The synaptic cell includes a communications medium operable to transmit input target data, learning hardware operable to compute synaptic weights based on the input target data; and a storage medium operable to store the computed weights.

In a still further aspect, the present invention is a self-programmable chip for real-time estimation, prediction, and control. The chip comprises a chip substrate providing a transmission medium, a plurality of synaptic cells with on-chip learning and weight storage integrated therein, and a plurality of control cells operable to route signals in an ordered fashion.

The self-programmable chip of the present invention is advantageous over previous attempted solutions because it accomplishes learning and weight storage on-chip without incurring added signal noise from transferring a signal between chips of a chip set. Further areas of applicability of the present invention will become apparent from the detailed description, drawings, and appended claims provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of the synaptic cell structure and interconnects including 3×3 identical synapse cells;

FIG. 2 is a diagram of the control cell structure and interconnects;

FIG. 3 is a representation of a hardware implementation of the control and synaptic cells;

FIG. 4 is a representation of an array structure of the implemented chip;

FIG. 5 is a flow-chart diagram depicting a method of operating a self-programmable chip according to the present invention;

FIG. 6 is a block diagram depicting three design layers of the self-programmable chip;

FIG. 7 is a block diagram providing an overview of the main building block structure of the self-programmable chip; and

FIG. 8 is a block diagram providing an overview of the interface signals required for operational testing of the programmable chip.

### DETAILED DESCRIPTION OF THE PREFERRED EMBODIMENT

The following description of the preferred embodiment is merely exemplary in nature and is in no way intended to limit the invention, its application, or uses. In the preferred embodiment, the self-programmable chip according to the present invention includes an on-chip, self-learning machine which computes by virtue of receiving input target data in the training mode and by letting the parameters (such as weights) settle to their steady state values within micro- to milliseconds. The core of the chip is a neurally-inspired, scalable (reconfigurable) array network for compatibility with very large scale integration. The chip is endowed with tested autolearning capability realized in hardware to achieve global task autolearning execution times in the micro- to milliseconds.

The core of the chip consists of basic building blocks of 4-quadrant multipliers, transconductance amplifiers, and active load resistances for analog (forward-)network processing and learning modules. Super-imposed on the processing network is a digital memory and control modules composed of D-Flip-flops, analog-to-digital converters, multiplying digital-to-analog converters, and comparators for parameter (weight) storage and analog-to-digital conversions. The architectural forward network (and learning modules) process in analog continuous-time mode while the (converged, steady state) weights/parameters can be stored on chip in digital form. The overall architectural design also adopts engineering methods from adaptive networks and optimization principles. The chip's design is based on mixed-mode circuit implementation wherein a forward network's processing and the learning module are analog while the weight storage and control signals are digital.

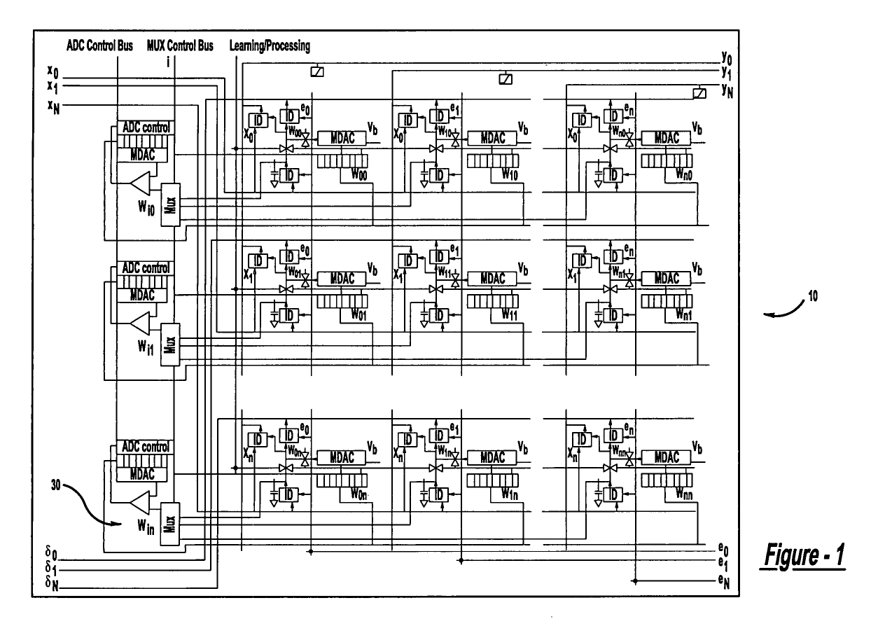

Referring to FIG. 1, synaptic cell structure 10 and interconnects are shown in the form of 3×3 identical synapse cells. Structure 10 has inputs x₀, x₁, and x_{N}, and has outputs y₀, y₁, and y_{N}. Structure 10 further has cascading outputs δ₀,δ₁, and δ_{N} and cascading inputs e₀, e₁, and e_{N} for cascading to other blocks. The processing stage includes sixteen neurons built using (analog) vector product multipliers and a sigmoid function. The multipliers use as operands an input vector and a weight vector. The input is common to all processing units and the weights belong to each neuron. The scalar product is then applied to the non-linear function resulting in the output of a unit neuron.

On-chip memory is designed as local digital memory. It is therefore necessary to add a stage where the present analog value of the weight is converted into a digital value using an analog-to-digital converter, and then converted back using a digital-to-analog converter. The memory is built by using five data flip-flops. The update law, however, uses a capacitor and one-dimension multipliers 1D. These multipliers are also used in each neuron to form the 17-dimension multipliers.

To optimize the number of analog-to-digital converters required for the conversion of the weight and still achieve good performance, a column of analog-to-digital converters was designed away from the neural network. This design uses multiplexers, decoders, control logic for the store mode, and the need of a clocked input to drive this logic. This clock would also drive the analog-to-digital converter, as it is designed using the successive approximations method. Having a clock in this section, however, does not imply that the neural network stops being asynchronous.

In FIG. 1, a column represents each neuron layer and each individual element of the array contains a synapse multiplication and a part of the update learning law. The nodes where the grid elements converge compute the sum of the synapses and proceed to apply a sigmoidal function for the output of the neuron. Moreover, by storing weights locally in digital format, but still using common analog-to-digital converters to perform the conversions, a more compact synapse cell is obtained, and the smallest buses are used throughout the chip.

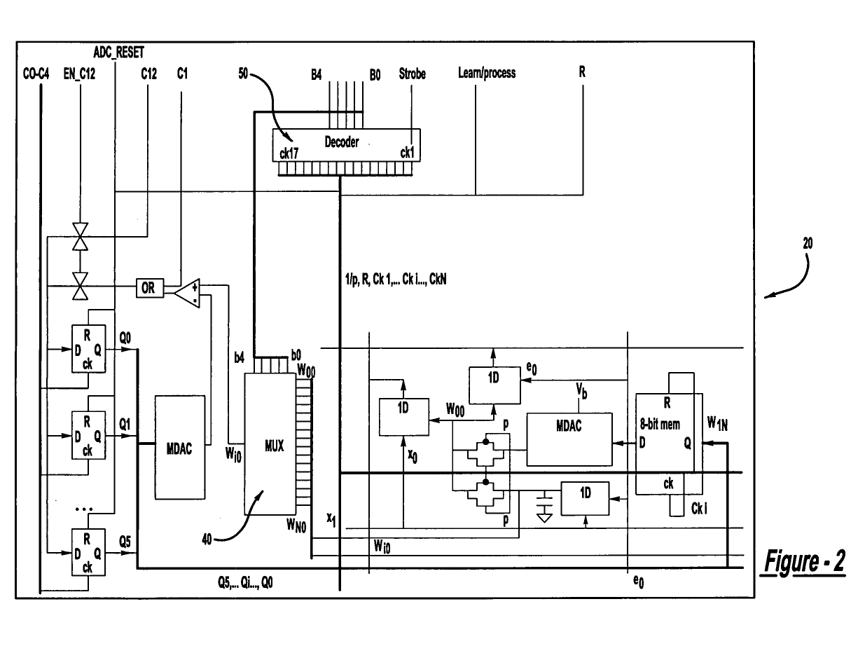

A control cell structure 20 and interconnects are shown in FIG. 2. The control cell 20 includes the entities contained on the left column 30 (FIG. 1). This cell 20 (FIG. 2) houses the successive approximation analog-to-digital converter ADC and the multiplexer MUX. It is based upon the multiplying digital-to-analog converter MDAC being used in the individual cells. The conversion is achieved by approaching the digital representation in steps, which suggests the use of a clocked logic. In the designed chip, the clocks to the D-type flip/flops are provided sequentially from the external pins. A programmable logic device and/or field programmable gate array in circuits can perform this task very easily. These flip-flops apply a constant digital input to the multiplying digital-to-analog converter MDAC for a short time and a feedback signal is computed and used to set the state for the next approximation.

FIG. 2 shows the basic control cell and the design of the analog-to-digital converter ADC. The multiplexer 40 and decoder 50 are used in tandem to apply the column signals to the analog-to-digital converter one at a time. The Multiplexer 40 and decoder 50 have the same codes reduced to four pins B0-B4.

The chip has two separate resets; one ADC₁₃RESET for the analog-to-digital converter and another R for the local weight flip-flops. Provision of separate resets, in conjunction with the C12 signals, allow the chip to be programmed (externally downloaded) with predetermined weights as well.

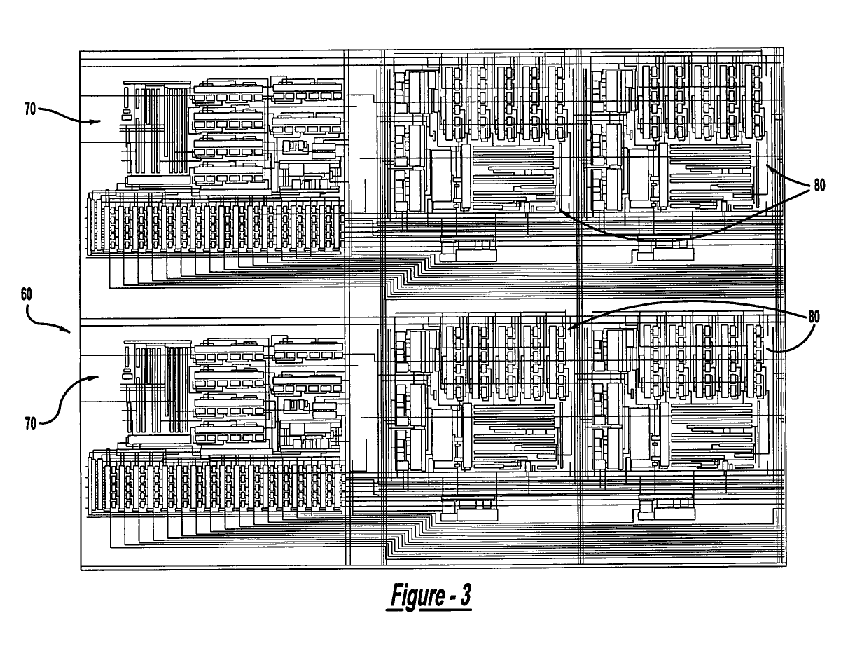

Referring now to FIG. 3, a hardware implementation 60 of the control cells 70 and synaptic cells 80 is presented. The various building cells, such as multiplying digital-to-analog converter, D-flip flops, comparator, OR gate, multiplexer, and transmission gates are included in the control blocks, while the multiplying digital-to-analog converter, Gilbert multiplier, local memory, temporary analog memory, and buffers are in the synaptic block.

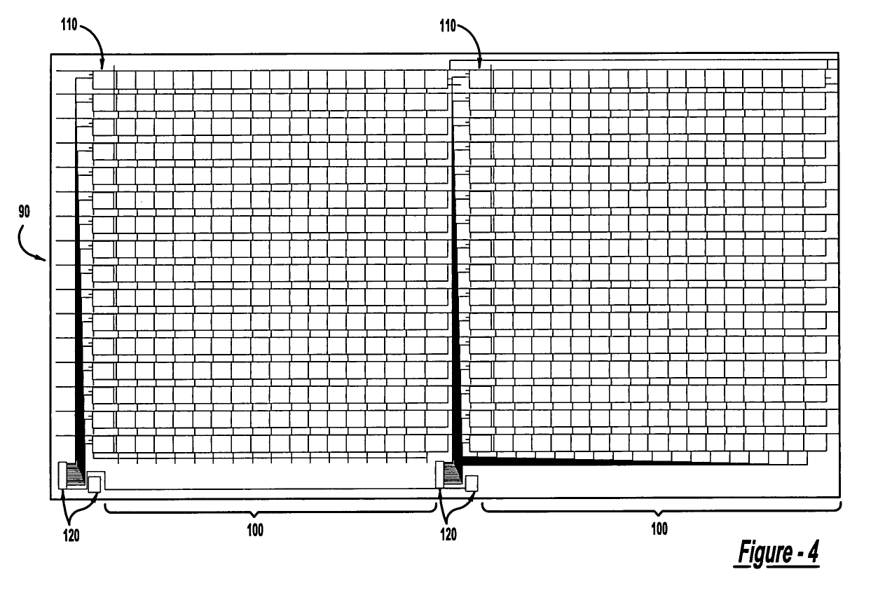

Referring now to FIG. 4, an array structure 90 of the implemented chip is shown. The array structure 90 comprises identical cells of 17×16 synaptic cells 100 (16 inputs and 1 bias) augmented by a column of control cells 110. The four cells 120 at the bottom are the decoders and de-multiplexers required for chip level programming of synaptic weights for both the blocks in parallel and are used for both row and column selections.

Several of these array structures 90 can be joined together in series and/or parallel to obtain a scalable neural structure. The intermediate outputs are also routed to the external pins which allow the application of recurrent neural learning structures to the chip.

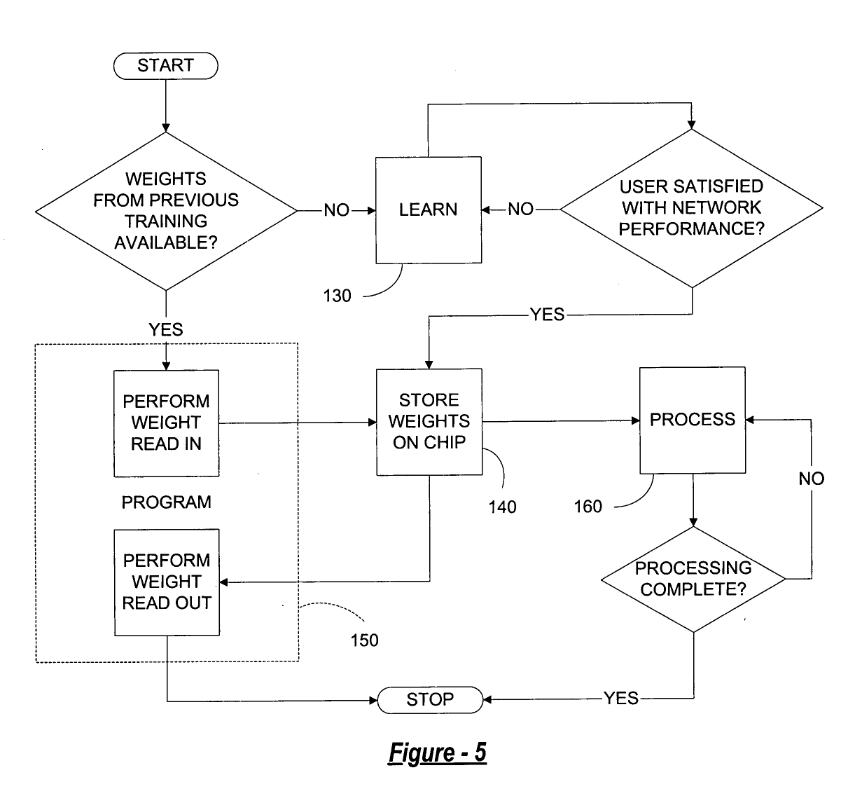

Referring to FIG. 5, a method of operation for the self-programmable chip of the present invention includes several steps. Therein, the chip operates in four modes: a learn mode 130; an on-chip store mode 140; a program read/write mode 150; and a process mode 160. In the learn mode 130, the chip activates the learning process based on the inputs and desired output targets supplied by the application or the user. Once the user is satisfied with the performance of the network in the learning mode 130, the store mode 140 saves the computed weights in on-chip static digital memory. The program mode 150 gives the chip the capability of weight read out or read in. The read in signifies programming the synapses/weights for applications where the chip has already been trained. The chip is thus ready to be used in the process mode 160 where the outputs are generated, i.e., computed, by the forward network. The chip is mixed-mode, mixed signal. It is mixed-mode in the sense that the learning phase is pure analog while the storage mode is analog/digital.

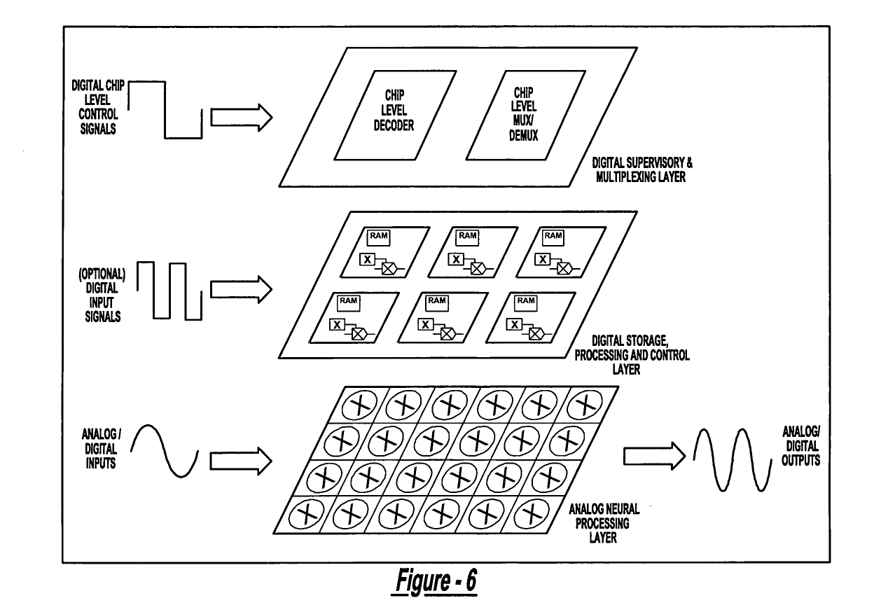

The design of the chip is composed of three design layers illustrated in FIG. 6, although these design layers can be implemented in any physical layer of the chip. An analog neural processing design layer serves as a base layer, and it functions to perform analog neural processing with analog inputs and outputs. A digital storage, processing and control layer is superimposed on the analog neural processing layer, and it is capable of receiving optional digital input signals. A digital supervising an processing design layer is further superimposed on the other two layers, and it functions based on input digital chip level control signals.

As discussed above, the main building block of the chip comprises of a 16×18 array of building cells. The first 16×1 cells are the digital cells, while the remaining 16×17 array is formed of synaptic cells. This array of synaptic cells on the output side is padded by another column of buffers for signals to be connected to other building blocks/padframe. This stage also includes difference amplifiers used for determination of error (difference between target inputs and block outputs for tuning the local weights).

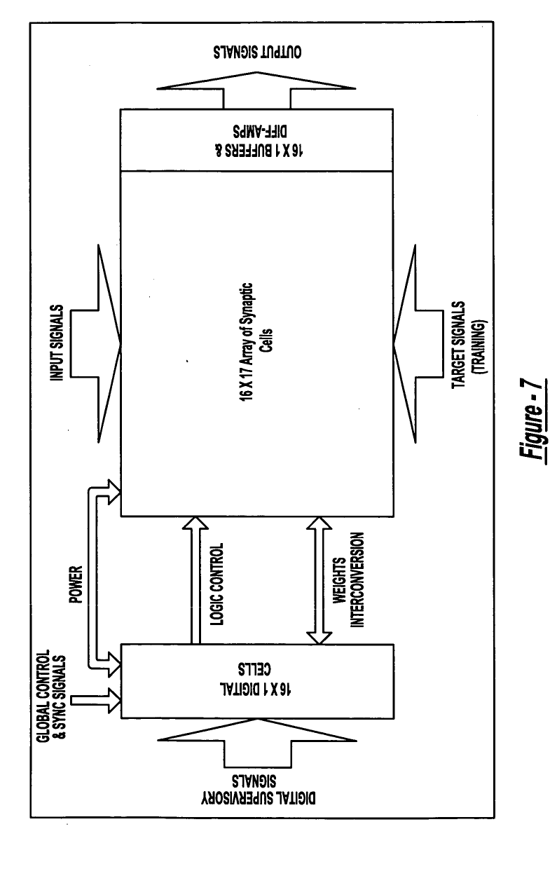

An overview of this structure is provided in FIG. 7. The digital cell array receives the digital supervisory signals directly from external pins plus some global synchronization signals generated within the chip. These signals are interpreted and appropriate logic signals for the control of synaptic cells are generated. The synaptic cells for the purpose of control are addressed coded in rows and columns. This allows for a mechanism of parallel management of building block resources as well as chip level resources.

The Synaptic array can be decomposed into cascaded processing stages. Each processing stage is composed of 16 neurons built using (×17) synaptic cells and a sigmoid function. Current bus bars are used to collect output currents from each cell in a processing stage. These bus bars run horizontally and vertically for common row/column outputs. Separately designed sigmoid functions and CMOS linear resistors are used to convert these currents to voltages.

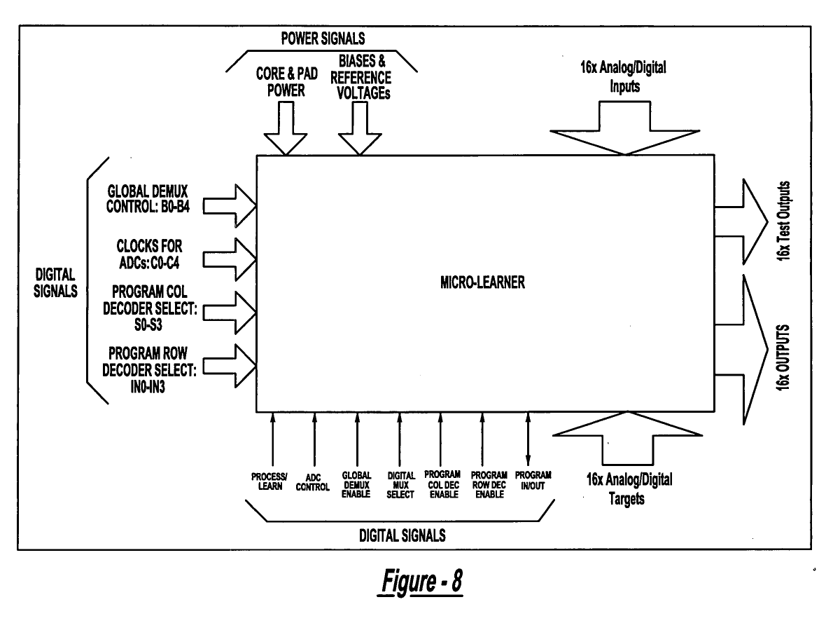

FIG. 8 provides an overview of the interface signals required for operational testing of this System on a Chip (SoC). The chip operates at 1.5 V power supply and therefore a stage of isolation/level conversion circuits have been developed for interfacing the chip with other standard digital hardware/test equipment. The signal inputs, network outputs, training inputs to the neural network can be either analog or digital. The biases and the reference signals are used to tune the performance characteristics of the learning elements. The digital/logic control signals B0-B4, C0-C4, SO-S3, IN0-IN3 are the signals for the digital control interface.

The chip's ability to perform weight read in and weight read out makes it operable as a programmable, general filter. Implementation of a programmable filter structure on a single chip proves particularly advantageous in the digital signal processing domain. In particular, the chip can be easily made to function as any of a low pass, high pass, band pas, or band reject filter. Also, any other filter function one can design can be stored in the form of weights communicable to the chip, thus causing the chip to function according to the filter design. Most importantly, however, the programmable chip can be used to design a filter to perform a given function on an input signal that would otherwise be difficult to design, and then store the computed weights so that the filter can be emulated at will by any chip of similar design, simply by communicating the weights to the chip.

One skilled in the art will recognize that the preferred embodiment of the present invention detailed above may be modified without departing from the spirit and scope of the present invention. For example, on-chip storage may be accomplished in the analog domain with capacitors, while learning may be accomplished in the digital domain. Further, additional chip layouts may be implemented to accommodate different chip substrate designs and signal routing methodologies. Moreover, the description of the invention is merely exemplary in nature and, thus, variations that do not depart from the gist of the invention are intended to be within the scope of the invention.

What is claimed is:

1. A self-programmable chip comprising:
a reconfigurable array processing network, providing:
(a) a feed-forward neural network; and
(b) learning modules; and
at least one control block providing digital memory and at least one control module supplying ordered signal routing functionality for said processing network.

2. The chip of claim 1, wherein the chip has a mixed-mode design.

3. The chip of claim 1, wherein the forward network and learning modules process in analog continuous-time mode, while the parameters are stored on chip in digital form.

4. The chip of claim 1, wherein said processing network includes a first interconnection structure.

5. The chip of claim 1, wherein said processing network includes a plurality of 4-quadrant multipliers operably coupled to said first interconnection structure.

6. The chip of claim 1, wherein said processing network includes a plurality of transconductance amplifiers operably coupled to said first interconnection structure.

7. The chip of claim 1, wherein said processing network includes a plurality of active load resistances operably coupled to said first interconnection structure.

8. The chip of claim 1, wherein the plurality of control blocks includes a second interconnection structure.

9. The chip of claim 1, wherein the plurality of control blocks includes a plurality of D-Flip-flops operably coupled to said second interconnection structure.

10. The chip of claim 1, wherein the plurality of control blocks includes a plurality of analog to digital converters operably coupled to said second interconnection structure.

11. The chip of claim 1, wherein the plurality of control blocks includes a plurality of multiplying digital to analog converters operably coupled to said second interconnection structure.

12. The chip of claim 1, wherein the plurality of control blocks includes a plurality of comparators operably coupled to said second interconnection structure and operable to perform parameter storage and analog to digital conversions.

13. A synaptic cell with on-chip learning and synaptic weight storage integrated therein, the synaptic cell comprising:
a communications medium operable to transmit input target data;
learning hardware operable to compute synaptic weights based on the input target data; and
a storage medium operable to store the computed weights,
wherein the synaptic cell is implemented in hardware on a single chip.

14. The synaptic cell of claim 13, wherein said communications medium comprises an interconnect data bus.

15. The synaptic cell of claim 13, wherein said learning hardware comprises a capacitor.

16. The synaptic cell of claim 13, wherein said learning hardware comprises a plurality of one-dimension multipliers.

17. The synaptic cell of claim 13 in communication with an analog to digital converter operable to convert the weights to digital form.

18. The synaptic cell of claim 13, wherein said storage medium comprises a plurality of data flip-flops operable to store the computed weights in digital form.

19. A self-programmable chip comprising:
a chip substrate providing a transmission medium;
a plurality of synaptic cells implemented on said chip substrate with on-chip learning and weight storage integrated therein; and
at least one control cell implemented on said chip substrate and operable to route signals to and from said plurality of synaptic cells in an ordered fashion.

20. The chip of claim 19, wherein at least one synaptic cell of said plurality of synaptic cells comprises learning hardware operable to compute weights based on input target data.

21. The chip of claim 20, wherein said learning hardware comprises a capacitor.

22. The chip of claim 20, wherein said learning hardware comprises a plurality of one-dimension multipliers.

23. The chip of claim 20, wherein said synaptic cell comprises an analog to digital converter operable to convert the weights to digital form.

24. The chip of claim 19, wherein at least one synaptic cell of said plurality of synaptic cells comprises a storage medium operable to store computed weights.

25. The chip of claim 24, wherein said storage medium comprises a plurality of data flip-flops operable to store the computed weights in digital form.

26. The chip of claim 19, wherein said chip substrate comprises an interconnect having a data bus.

27. The chip of claim 19, wherein said plurality of synaptic cells and a plurality of said control cells is organized into an array structure comprising identical cells of 17×16 synaptic cells augmented by a column of control cells, the chip further comprising decoders and de-multiplexers operable to provide chip level programming of synaptic weights for multiple blocks in parallel, said decoders and demultiplexers used for both row and column selections.

28. A method of operating a self-programmable chip comprising:
activating a learning mode;
activating a storage mode; and
activating a process mode.

29. The method of claim 28 further comprising activating a program mode.

30. The method of claim 29, wherein said activating a program mode comprises activating a program mode, wherein the chip accomplishes weight read out.

31. The method of claim 29, wherein said activating a program mode comprises activating a program mode, wherein the chip accomplishes weight read in.

32. The method of claim 29, wherein said activating a program mode comprises activating a program mode, wherein the chip accomplishes weight read in, wherein the weight read in signifies programming the weights for applications where the chip has already been trained.

33. The method of claim 28, wherein said activating a learning mode comprises activating a learning mode that is purely analog.

34. The method of claim 28, wherein said activating a learning mode comprises activating a learning mode, wherein the chip activates a learning process based on inputs and desired output targets supplied by at least one of an application and a user.

35. The method of claim 28, wherein said activating a storage mode comprises activating a storage mode that is analog-digital.

36. The method of claim 28, wherein said activating a storage mode comprises activating a storage mode, wherein a user, once satisfied with performance of a chip network in the learning mode, saves computed weights in on-chip static digital memory.

37. The method of claim 28, wherein said activating a storage mode comprises automatically activating a storage mode after passage of a predetermined amount of time since activation of the learning mode.

38. The method of claim 28, wherein said activating a process mode comprises activating a process mode, wherein outputs are generated by a chip forward network.

39. A method of making a self-programmable chip, comprising:
providing a chip substrate having a databus;
operably attaching a plurality of synaptic cells to the chip substrate, wherein the synaptic cells have on-chip learning and synaptic weight storage integrated therein; and
operably attaching at least one control cell to the chip substrate, wherein the control cells are operable to route signals in an ordered fashion.

40. The method of claim 39, wherein said operably attaching a plurality of synaptic cells to the chip substrate comprises:
operably attaching a capacitor to the chip substrate; and
operably attaching a plurality of one-dimension multipliers to the chip substrate in the vicinity of the capacitor; and
interconnecting the capacitor and the one dimensional multipliers in a configuration causing the plurality of the one-dimension multipliers to scale an input target signal, while the capacitor allows a voltage of the input target signal to cause a synaptic weight to settle over time.

41. The method of claim 40, wherein said operably attaching a plurality of synaptic cells to the chip substrate comprises:
operably attaching an analog to digital converter to the chip substrate in the vicinity of the capacitor, wherein the analog to digital converter is operable to convert the synaptic weight to digital form; and
operably attaching at least one data flip-flop to the chip substrate in the vicinity of the analog to digital converter, wherein the data flip-flop is operable to store the synaptic weight in digital form.

42. A programmable filter comprising:
a chip substrate providing a transmission medium;
a programmable filter structure implemented on said chip substrate and operable to receive an input signal, filter the input signal according to predetermined weights, and output the filtered signal, said programmable filter structure comprising:
(a) an input operable to receive data comprising predetermined weights;
(b) a storage medium operable to store the predetermined weights; and
(c) an output operable to communicate stored weights off chip.
